(19) United States
(12) Patent Application Publication
(10) Pub. No.: US 2013/0197933 A1
(43) Pub. Date: Aug. 1, 2013

(54) Healthcare and Medical Information Management System

(71) Applicants: Jennifer Whitlow, St. Peters, MO (US); Martin Hoffmann, St. Louis, MO (US)

(72) Inventors: Jennifer Whitlow, St. Peters, MO (US); Martin Hoffmann, St. Louis, MO (US)

(73) Assignee: AFFILIATED COMPUTER SERVICES, INC., Dallas, TX (US)

(21) Appl. No.: 13/359,227

(22) Filed: Jan. 26, 2012

(51) Int. Cl. G06Q 50/24

(52) U.S. Cl. 705/3

(57) ABSTRACT

A healthcare and medical information system comprising an administrator interface configured to communicate with a device, to integrate healthcare and medical information for a plurality of individuals including a user of the device, and to provide the device access to and sharing of the healthcare and medical information associated with the user of the device. Also disclosed is an apparatus comprising a processor configured to remotely access personal healthcare and medical information of a user registered with a device on a database of integrated healthcare and medical information for a group of individuals, and enable a second device to remotely access at least some of the healthcare and medical information of the user at the database.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Some employees receive employer benefits that include health insurance and possibly other healthcare benefits. Health insurance provides financial protection against the risk of incurring medical expenses among individuals. Insurance coverage is typically provided by an employer-sponsored insurance plan. The employer, employee, or both pay an insurer (or insurance provider) a monthly premium to ensure that money is available for paying for the healthcare benefits that are specified in the insurance plan. The healthcare benefits are administered to the employee by the employer, such as a private business, a government agency, or a nonprofit organization. Typically, the employer administers the insurance plan or benefits but does not provide or engage in the act of insurance. The specific benefits and coverage details can be found in an employer's summary plan description (SPD). If an employee needs to provide information about his/her health or medical insurance plan, e.g., to a doctor or other healthcare provider, then the employee may need to carry a pre-printed insurance card or write this information down and provide the information to the healthcare provider. Alternatively, the employee can look up the information electronically, such as using a laptop or desktop computer. The employee can also share or coordinate his or her healthcare benefits information in similar manners.

### SUMMARY

In an embodiment, the disclosure includes a healthcare and medical information management system comprising an administrator interface configured to communicate with a device, to integrate healthcare and medical information for a plurality of individuals including a user of the device, and to provide the device access to and sharing of the healthcare and medical information associated with the user of the device.

In another embodiment, the disclosure includes an apparatus comprising a processor configured to remotely access personal healthcare and medical information of a user registered with a device on a database of integrated healthcare and medical information for a group of individuals, and enable a second device to remotely access at least some of the healthcare and medical information of the user at the database.

In yet another embodiment, the disclosure includes a healthcare and medical information access and sharing application comprising instructions that cause a mobile device to authenticate a user, establish a connection with a medical benefits administrator interface that manages healthcare and medical information for a plurality of individuals including the authenticated user, access remotely healthcare and medical information associated with the authenticated user, display the healthcare and medical information on the mobile device, and share selected healthcare and medical information of the authenticated user with one or more personal devices.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a healthcare and medical information management system.

FIG. 2 is a flowchart of an embodiment of a healthcare and medical information management method.

FIG. 3 is a schematic diagram of an embodiment of a radio unit.

FIG. 4 is a schematic diagram of an embodiment of a general-purpose computer system.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Current means to provide and share healthcare benefits information for employees may involve copying and carrying the information manually, e.g., on notebooks, insurance cards, or paper printouts, and accessing the information electronically, e.g., on computers or other electronic devices. The healthcare benefits may also be shared using manual and electronic communications methods, such as emails, websites, phone calls, fax, and mail. With the increase in popularity and use of mobile smartphones, some smartphone applications may also allow accessing healthcare benefits, medical information about the employer and possibly his/her dependents, or both. However, separate smartphone applications or websites may be associated with different benefits providers, (e.g., insurance provider and flexible medical spending accounts) and may not provide an employer and associated employees integration of information from the different providers. For example, the employees under the same employer may need to access a smartphone application or a website for each different insurance provider that contracts with the same employer to provide healthcare benefits to employees. Such means for providing and sharing healthcare benefits and other medical information about the employee may not provide sufficiently easy integration for managing healthcare benefits and medical information for employees.

Disclosed herein is a system and method for allowing individuals to efficiently and conveniently access and share integrated healthcare and medical information. The healthcare and medical information may comprise personal medical/medication records, medical images, and healthcare benefits (e.g., medical insurance) information, which may be provided by a plurality of healthcare services and healthcare benefits providers for the individual. The healthcare and medical information may also comprise medical/medication records and healthcare benefits information about one or more dependents of the individuals. Specifically, the healthcare and medical information may be accessed and shared by an individual using a mobile or personal device that is configured for communicating electronic data, such as a smartphone. The personal device may run an application or a program configured to manage the healthcare and medical information and comprising a plurality of functions for accessing and sharing the information. The healthcare and medical information may be accessed by and shared with a healthcare provider, such as a doctor, a pharmacist, or a nurse. The healthcare and medical information may also be shared with a third party for various reasons, such as sharing dependents' information with a nanny in charge of taking care of the individual's children. The healthcare and medical information may also be integrated for a plurality of healthcare services and healthcare benefits providers that are associated with an employer of the individual (employee).

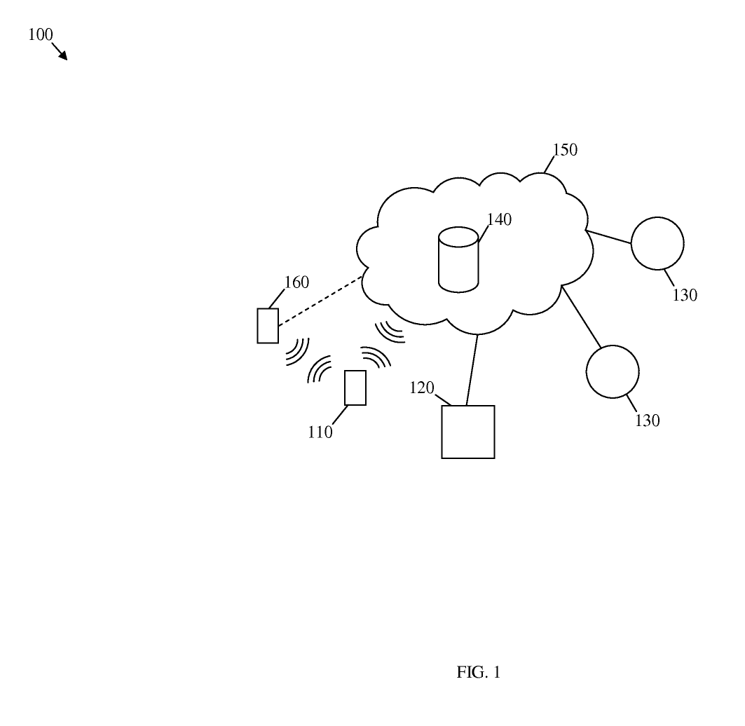

FIG. 1 illustrates an embodiment of a healthcare and medical information management system 100 for accessing and sharing integrated healthcare and medical information for an individual, e.g. an employee. The healthcare and medical information management system 100 may comprise a personal device 110, a healthcare benefits administrator interface 120, one or more healthcare benefits provider interfaces 130, a healthcare benefits database 140, and a network 150. Additionally, the healthcare and medical information management system 100 may comprise at least one second personal device 160. The components of the healthcare and medical information management system 100 may be arranged as shown in FIG. 1 or in any other suitable arrangement.

The healthcare and medical information for the individual may comprise information related to the individual's healthcare records, information related to one or more healthcare benefits (or insurance) providers for the individual, personal profile information about the individual, or combinations thereof. The individual's healthcare records may comprise the healthcare benefits of the individual and optionally one or more dependents of the individual, such as health, dental, pharmacy and/or vision insurance coverage plans. The different insurance coverage plans for the individual (and his/her dependents if available) may be integrated from one or a plurality of sources, e.g., health insurance providers. The healthcare records may also comprise medication and other medical records of the individual and optionally his/her dependents, such as medical prescriptions allergies, health screenings, immunizations, and family medical history. The health benefits providers' information may comprise contact information (e.g., phone numbers, email addresses, mail/physical addresses), insurance card information, group/individual insurance account numbers, and/or other information about the providers. The personal profile information about the individual may comprise the individual's full name, phone number, email address, mail/physical address, and/or other personal information.

The individual may be an employee subscribed to healthcare benefits provided by an employer (e.g., a public, private, or non-profit organization). The healthcare benefits comprise a plurality of coverage plans that may be provided by one or more health insurance providers (e.g., for health, dental, pharmacy and/or vision insurance) in contract with the employer. The healthcare benefits may also cover one or more of the individual's dependents.

The personal device 110 may be any mobile or personal device configured to access and share the healthcare and medical information for the individual (and for his/her dependents if available). The personal devices 110 may be operated by one or more corresponding registered individuals or users (e.g., an employee). The personal device 110 may comprise one or more wireless access technologies or interfaces (e.g., in a chip or component) that enable the personal device 110 to establish fixed (wired) and/or wireless links with the network 150 and/or any of the remaining components of the healthcare and medical information management system 100. The personal device 110 may communicate with the network 150, the database 140, and/or any of the remaining components to exchange healthcare and medical information. The personal device 110 may communicate, via the network 150 or via any other network or interface, with the database 140 and/or any of the other components.

The personal device 110 may comprise one or more wireless technology interfaces (components) that may communicate with one or more of the other components. Examples of wireless technologies and interfaces that may be used in the personal device 110 (and correspondingly in the other components in communications with the personal device 110) include a Bluetooth interface, an Institute of Electrical and Electronics Engineers (IEEE) 802.11 compliant (or WiFi™) wireless interface, a near field communication (NFC) link, an Infrared Data Association (IrDa) interface, a Radio-frequency identification (RFID) interface or a radio frequency transponder, a reflective antenna chip (electronic tag), cellular interface (e.g., third Generation Partnership Project (3GPP) interface), and/or any other wireless technology interface that may be applicable.

The personal device 110 may also comprise a visual display (or display screen) that allows the individual or user to view and share at least some of the healthcare and medical information. The information may be shared by granting read-only access to the information by another component, such as the second personal device 160. The sharing of the information may be controlled by the individual using the personal device 110 that may run proprietary software code to generate a unique or corresponding multi-digit sharing key string, e.g., comprised of a random combination of numbers and letters. The unique sharing key may only be activated by one user of the second personal device 160. Sharing of selected information with further users of compatible devices may require the initiation and creation of additional, e.g., one-time use, multi-digit sharing key strings. The unique multi-digit sharing key string may be sent to other devices through an email application resident on the device, or may be transmitted verbally to other users. Sharing of the user's health insurance data may also be permitted via email and/or fax to healthcare providers. The personal device 110 may deliver a read-only output of user's selected health insurance data (e.g., insurance provider's contact information, coverage information, including copayments, coinsurance, deductibles and/or out-of-pocket maximums, group/individual insurance account numbers and/or other information about the insurance providers). Sharing via email and/or fax may also be permitted for user's dependents. The personal device 110 may also comprise other types of input/output (I/O) interfaces, including a touch screen or physical keyboard, a microphone, a camera, a speaker, wireless interfaces, infrared interfaces, and/or other I/O interfaces. The personal device 110 may also comprise a chargeable battery that may power the personal device 110. The personal device 110 may be a mobile device, such as a smartphone, a laptop computer, a tablet computer (or pad), an electronic book (ebook) reader, or other mobile or personal devices that may be used to communicate wirelessly (or via a fixed link) with the other components and allow the user to view and share information. The personal device 110 may also be any computer or processor based device that may use fixed (or wireless) links to communicate with the other components, such as a desktop computer.

The healthcare benefits administrator interface 120 may be any system, device, or component configured to communicate healthcare and medical information with the personal device 110, e.g., via the network 150. The healthcare benefits administrator interface 120 may be part of a healthcare benefits administrator system configured to administer and integrate one or more healthcare benefits accounts, e.g., health insurance coverage plans, for one or more corresponding individuals. For instance, the healthcare benefits administrator system may be operated by an employer to administer the healthcare benefits accounts for one or more employees including the individual or user of the personal device 110. The healthcare benefits administrator system may administer the healthcare benefits accounts, but may not provide the health insurance coverage plans for the employees or individuals. Instead, the healthcare benefits administrator system may communicate with one or more systems associated with one or more healthcare benefits providers, which may provide health insurance coverage plans for the individuals. The healthcare benefits system administrator may also integrate the information from the different providers, which may facilitate access to the individuals or employees. In some embodiments, the healthcare benefits administrator system may be implemented by a third party (a healthcare benefits accounts administrator) to administer the healthcare benefits accounts for a plurality of individuals that may be subscribers to the health insurance coverage plans by the healthcare benefits providers.

The healthcare benefits administrator system may be operated or supervised by trained or in-charge personnel, such as a worker, by automated systems, such as a server or other machines, or both. The healthcare benefits administrator interface 120 may comprise computer or similar devices that may use fixed (wired) or wireless technologies or interfaces to communicate with the personal device 110, e.g., via the network 150. Examples of the devices that may be used at the healthcare benefits administrator interface 120 may include desktop computers, laptop computers, and/or terminal equipment (e.g., keyboards and computer screens) that may be coupled to servers (e.g., in the network 150). The healthcare benefits administrator interface 120 may be linked to the network 150 via wireless and/or fixed links. The healthcare benefits administrator interface 120 may also communicate and share information in the healthcare benefits database 140, e.g., via the network 150. The healthcare benefits administrator interface 120 and the healthcare benefits administrator system may be located at a facility or location corresponding to the healthcare benefits administrator, such as a building.

The healthcare benefits provider interfaces 130 may be any systems, devices, or components configured to communicate healthcare and medical information with the healthcare benefits administrator interface 120 and/or the personal device 110, e.g., via the network 150. For instance, the communication of healthcare and medical information may be achieved using real-time push-messaging technology in addition to storing the information in a designated message inbox within a smartphone application on the personal devices 110 and 160. The healthcare benefits provider interface 130 may be part of the healthcare benefits providers' systems that are configured to maintain and manage one or more healthcare benefits accounts provided by one or more healthcare benefits providers for one or more individuals. For instance, the healthcare benefits providers' systems may be implemented by health insurance providers associated with the employer (or a third party administrator of healthcare benefits) of the individual or user of the personal device 110.

Similar to the healthcare benefits administrator system, the healthcare benefits providers' systems may be operated or supervised by trained or in-charge personnel and/or by automated systems. The healthcare benefits provider interfaces 130 may also comprise computer or similar devices that may use fixed or wireless technologies or interfaces, as described above, to communicate with the personal device 110 and/or the healthcare benefits administrator interface 120, e.g., via the network 150. The healthcare benefits provider interfaces 130 may also communicate and share information in the healthcare benefits database 140, e.g., via the network 150. The healthcare benefits provider interfaces 130 and the healthcare benefits providers' systems may be located at the healthcare benefits providers' locations.

The healthcare benefits database 140 may be any device, apparatus, or component configured to store healthcare and medical information for one or a plurality of individuals, including the user of the personal device 110. The healthcare benefits database 140 may comprise a storage medium, such as one or more disk storages, that stores and maintains information related to healthcare benefits (e.g., health insurance plan) and/or medication and other medical records of the individuals (and of their dependents if available). As described above, the individuals (e.g., employees) may be associated with one or more healthcare benefits providers (e.g., healthcare insurance companies) and one or more health benefits administrators (e.g., employers or third parties). The healthcare benefits database 140 may communicate with the personal device 110, the healthcare benefits administrator interface 120, and/or the healthcare benefits provider interfaces 130, e.g., via the network 150. For instance, the healthcare benefits database 140 may be accessed or shared by the other components. The healthcare benefits administrator system and/or the healthcare benefits providers' systems may comprise local databases that may store at least some of the information in the healthcare benefits database 140. In an embodiment, the healthcare benefits database 140 may be distributed at a plurality of sites coupled to the network 150, such as at least at one of the healthcare benefits administrator system and/or the healthcare benefits providers' systems.

The network 150 may be any network that communicates with and allows communications between the personal device 110, the healthcare benefits administrator interface 120, the healthcare benefits provider interfaces 130, the healthcare benefits database 140, the second personal device 160, or combinations thereof. The network 150 may comprise one or a plurality of access/transport networks that may be based on one or more network transport technologies and protocols. Examples of the network 150 may include the Internet, Ethernet networks, optical backbone networks, digital subscriber line (DSL) networks, local area networks (LANs), wireless area networks (WANs), other types of telecommunication networks, or combinations thereof.

The second personal device 160 may be a mobile or personal device similar to the personal device 110 and may be configured to access any of the information described above with the personal device 110. The second personal device 160 may access information that may be authorized by the personal device 110. For instance, a link for the information may be forwarded from the personal device 110 to the second personal device 160 to allow the second personal device 160 to access the information. The second personal device 160 may communicate with the personal device 110 directly or via the network 150 or other network, e.g., using fixed and/or wireless links or technologies, as described above. The second personal device 160 may be used or operated by a second individual or user that may not have permission to access the healthcare and medical information without authorization from the individual or the user of the personal device 110. For example, the second individual or user may be a doctor, a pharmacist, or a nurse in charge of the user of the personal device 110 or a dependent of the user of the personal device 110. In another example, the second individual may be a nanny in charge of taking care of the individual's children or any person that may be authorized by the individual to access the individual healthcare and medical information for various reasons.

To access and share the healthcare and medical information, the personal device 110 may host a healthcare and medical information application (e.g., a program or software). For example, the personal device 110 may be a smartphone (e.g., an iPhone™ or Android™ based smartphone) that hosts a smartphone application (e.g., an iPhone™ app). The healthcare and medical information application may be configured to handle a plurality of operations and functions related to accessing and sharing healthcare and medical information. The accessed and shared healthcare and medical information may comprise medical/medication records and/or healthcare benefits information for a user of the personal device 110 and optionally of one or more dependents of the user. The healthcare and medical information application may be configured to receive the information from the healthcare benefits administrator interface 120, one or more healthcare benefits provider interfaces 130, and/or the healthcare benefits database 140, and to share at least some of the information with the second personal device 160.

The healthcare and medical information may be downloaded to the personal device 110 via the Internet or other means, such as for viewing and editing purposes of each individual screen only. The information may be transferred using secure communications channels and encryption levels. To protect the security of personal health and medical data, and in compliance with Health Insurance Portability and Accountability Act (HIPAA) regulations, the healthcare and medical information may not be stored on the personal devices 110 and 160 permanently nor temporarily in a cached form. In some embodiments, similar or different versions of the healthcare and medical information application may be hosted or used on the healthcare benefits administrator interface 120 and the second personal device 160. For example, a healthcare benefits administration application may be used on the healthcare benefits administrator interface 120 to share or send information to the personal device 110 and a healthcare and medical information sharing application may be used on the second personal device 160 to share and receive information from the personal device 110.

The healthcare and medical information application may comprise a function for user registration, which may allow registering an individual with the personal device 110, e.g., an employee that receives healthcare benefits from an employer. This function may be selected using the application, e.g., by selecting this function in a menu or by selecting/clicking on a corresponding position on the application view. To register, the individual may use a unique personal identification information, such as an access code, a personal identification number (PIN), a user identifier (ID), a user login name, a user password, and/or other user identification means that identifies the individual as the user of the personal device 110. The individual may need to register with the personal device 110 using the healthcare and medical information application before using the operations and functions for accessing and sharing the healthcare and medical information. The individual may use the application (after installing the application on the personal device 110) to implement the registration process.

During registration, the individual may enter registration information, e.g., the identification information above, in a registration form in the application. The healthcare and medical information application may create an access account for the individual after registration, which may comprise the individual's registration information. The individual may also enter during registration his/her personal information (e.g., full name, phone number, email address, mail/physical address, and/or other personal information), and/or healthcare insurance number, and optionally other related information. This information may be part of the registration information.

At least some of the registration information may be used after registration as authentication information to allow the individual to access and use the healthcare and medical information application and the application's functions. At initial registration, a credentialing process may involve a unique, multi-digit, one-time, system-generated verification code supplied by the healthcare benefits administrator interface 120, which may pair the personal information stored in healthcare benefits administrator interface 120, one or more healthcare benefits provider interfaces 130, and/or the healthcare benefits database 140, with the individual's unique personal identification information, such as an access code, a PIN, an ID, a user login name, a user password, and/or other user identification means that identifies the individual as the user of the personal device 110. The authentication information may be used to associate the individual with the personal device 110 and the corresponding access account. The authentication information may be used to authenticate and verify the identity of the user of the personal device 110 as the registered user before authorizing the user to use the healthcare and medical information application and the related functions. For instance, the user may be prompted to enter (or login using) the authentication information every time before activating or using the application or the functions on the personal device 110.

The registration information may be edited or changed by the registered user at any time (e.g., during or after registration), e.g., with the exception of the verification code that may not be edited. Additionally, a plurality of individuals (e.g., employees for one or more employers) may be registered with the same personal device 110 using a plurality of separate access accounts and corresponding registration information. Each individual may only be allowed to access his/her corresponding access account on the application using the corresponding authentication information. The registration and authentication information may be stored remotely from the personal device 110 (e.g. in the healthcare benefits database 140, the healthcare benefits administrator system, and/or other components), locally (e.g., in memory) on the personal device 110, or both.

Upon recognizing the user and authorizing his/her access, one or more links and/or descriptors for the healthcare and medical information may be delivered to the personal device 110 from the healthcare benefits database 140, healthcare benefits administrator interface 120, one or more healthcare benefits provider interfaces 130, outside contracted data sources, or combinations thereof. The links/descriptors may comprise universal resource locators (URLs), tags, file descriptors, HyperText Markup Language (links), and/or any other types of suitable links for accessing files or electronic data, e.g., remotely. The links/descriptors may be combined by the application on the personal device 110. The links/descriptors may be used to access and share the healthcare and medical information corresponding to the individual associated with the personal device 110 and may be erased from the smartphone upon discontinuing the access or closing the application. The personal device 110 may receive links/descriptors to the information, maintain (e.g., temporarily) the links/descriptors, and use the links/descriptors to access the information that may be stored, as described above, on the other components.

However, the personal device 110 may not store or cache the actual information data locally. Instead the information data may be accessed remotely on a secure server environment, e.g., at the healthcare benefits administrator system, the healthcare benefits database 140, and/or other components, which may improve security and privacy for handling the information. For example, the links (or descriptors) may be deleted when the user changes the screen view on the personal device 110 or selects another function and hence moves to a different view in the application. If the user needs to access previously accessed information, then the deleted links may be downloaded again. In another embodiment, the personal device 110 may store or cache at least some of the information data locally, but only temporarily, and may delete and remove the stored or cached information after access, e.g., without prompting the user to do so. Storing or caching some of the information data temporarily may improve the processing time to view the information on the personal device 110.

The healthcare and medical information application may comprise a function for entering medical/medication records and history information on the personal device 110. Alternatively, information may be entered on the Internet using a secure, one-time data-entry page employing a specified URL that may be unique to the account of the user of personal device 110. The medical/medication records and history information may belong to the individual or user of the personal device 110 and optionally, to his/her dependent(s). The medical/medication records and history information may be received/entered using the application, e.g., by selecting this function in a menu or by selecting/clicking on a corresponding position on the application view. The medical/medication records and history information may comprise medical treatment (e.g., surgery), medication (e.g., prescription), and/or medical family history information. The information may be entered by the user on the personal device 110, e.g., using a keyboard or a touch screen, or may be received electronically, e.g., using email or text messaging, or both. Other means of electronic communications (e.g., using fixed and/or wireless links), I/O interfaces, or both may also be used to enter or receive such information.

Additionally, the operations and functions of the healthcare and medical information may include accessing healthcare records and benefits information, sharing information, receiving updates, promoting good health, providing reminders, and/or other functions. The function for accessing healthcare records may be selected in a menu or by selecting/clicking on a corresponding position on the application view. In an embodiment, the function for accessing healthcare records may be labeled as “My Info”. The user may use this function to display and view the healthcare and medical information. The information may be remotely stored and accessed and hence displayed, for instance using downloaded links as described above. The accessed and displayed information may comprise the user's healthcare records, which may comprise medication records (e.g., medical prescription and treatment) records, medical records (e.g., personal and family medical history and diagnoses), and/or other health records of the individual and optionally of his/her dependents and pets if available. At least some of the medication/medical records may be entered by the user or received from a healthcare provider (e.g., a doctor or a pharmacist) and/or other databases or healthcare related sources using the function for entering medical/medication records and history information described above.

The healthcare records may also comprise the healthcare benefits of the individual (and his/her dependents), e.g., health, dental, and/or vision insurance coverage plans that may be provided by one or more healthcare benefits providers. For instance, a summary of at least some of the healthcare benefits information may be displayed. The displayed and accessed information may also comprise information about the health insurance providers, e.g., contact information, insurance card information, group/individual insurance account numbers, and/or other information about the insurance providers. For example, the function may display on the screen of the personal device 110 an insurance card image for the user, e.g., in Portable Document Format (PDF) or other suitable format. Personal profile information about the user (and his/her dependents) may also be similarly accessed and displayed.

The function for accessing healthcare records may also enable the user to access and view healthcare spending account information. For instance, the healthcare spending account information may comprise the deductible amount remaining for an insurance coverage plan, flexible medical account information, other healthcare related spending information, or combinations thereof. The function may provide the user access and viewing to such healthcare account spending information in real-time. The function may comprise one or separate tools that may be selected or activated to access and view different account spending information.

The function for sharing information may be selected in a menu or by selecting/clicking on a corresponding position on the application view. In an embodiment, the function for sharing information may be labeled as “My Network”. The user may use this function to share or send at least some of the information described above to another device or system, such as the second personal device 160. The information may be encrypted before being forwarded to provide security and privacy. The second personal device 160 may be used by a healthcare provider or a third party that may need to access healthcare and medical information about the user of the personal device 110 and of his/her dependents if available. For example, a doctor or pharmacist may need insurance information about the user or a nanny of the user's children may need medication/medical records information for the children. The information may also be shared with other users of the same or other devices that may belong to a group including the user of the personal device 110, such as a plurality of employees for the same employer, a plurality of patients for the same doctor, members of the family, or a plurality of individuals that are members of the same therapy group.

By sending the information to another user of another device (the personal device 160), the user of the personal device 110 may allow the other user to access the forwarded information, but not necessarily the remaining information corresponding to the account of the user of the personal device 110. Thus, the user of the personal device 110 may select which information to share with another device, such as device 160. This may create a secure network for sharing only authorized information among a plurality of users on one or more devices. As described above, the information may be shared by granting read-only real-time access to the information by another component, such as the second personal device 160, and the sharing may be controlled using multi-digit sharing key strings The applications on the different devices may be configured to encrypt the information before sending and decrypt the information after receiving. In some embodiments, links for some of the information may be sent via other means such as emails, text messages, or similar communications. For example, insurance card information (e.g., deductibles, insurance company, etc.) or an electronic image of the insurance card may be sent via email or facsimile. In an embodiment, the function for sharing information may also include an option to integrate, at least partially, other networking platforms or applications.

The function for receiving updates may be selected or activated in a menu or by selecting/clicking on a corresponding position on the application view. In an embodiment, the function for receiving updates may be labeled as “My Inbox”, e.g., within a section of the application labeled “My Benefits”. In another embodiment, the function for receiving updates may be labeled “Reminders”. The user may use this function to receive updates or changes, e.g., in the form of messages, from the healthcare benefits administrator interface 120 and/or one or more of the healthcare benefits provider interfaces 130. The healthcare benefits administrator interface 120 may send updates and changes about the healthcare and medical information, e.g., in the healthcare benefits account that corresponds to an individual to the personal device 110 associated with that individual. Some of the changes and updates may also be forwarded from the healthcare benefits provider interfaces 130 to the personal device 110 via the healthcare benefits administrator interface 120.

When the function is selected, the updates may be received if available. Alternatively, the function may be activated (turned on) and hence the personal device 110 and the healthcare and medical information application may receive updates when available or on a regular basis (e.g., periodically). The function may provide a communication channel between the healthcare benefits administrator interface 120 and the personal device 110 for pushing updates and changes and optionally notices and alerts concerning the healthcare benefits of the individual. For instance, the communication channel may be used by an employer to push (or broadcast) updates and other information to the employees with registered healthcare benefits accounts.

The function for promoting good health may be selected in a menu or by selecting/clicking on a corresponding position on the application view. In an embodiment, the function for promoting good health may be labeled as “Live Well”. This function may provide tools for the user and/or enable the user to view or receive information about healthy living, raising personal health awareness, healthy behavior, habits, and activities, or combinations thereof. The function may also enable third parties to push information to the application about health awareness. For example, the function may access Internet sources that provide such information and may comprise one or more tools for monitoring weight changes, daily calorie intakes, workout program scheduling, and/or similar tools. The function may also enable a third party to send or push information that may be relevant to the user's well-being onto the application or the personal device 110. The third party may push such information based on one or more criteria for users (user group criteria).

The function for providing reminders may be selected or activated in a menu or by selecting/clicking on a corresponding position on the application view. In an embodiment, the function for providing reminders may be labeled as “Reminders”. This function may comprise a tool to provide the user with one or more reminders related to the healthcare and medical information or other information. The reminders may comprise predetermined reminders based on predetermined criteria, such as weekly or monthly reminders to check for updates or changes or to view healthcare related bills. The reminders may also comprise reminders that are set by the user based on user-determined criteria, such as reminders for scheduling an appointment with a doctor, for a prescheduled doctor visit, and/or for filling a prescription at a pharmacy.

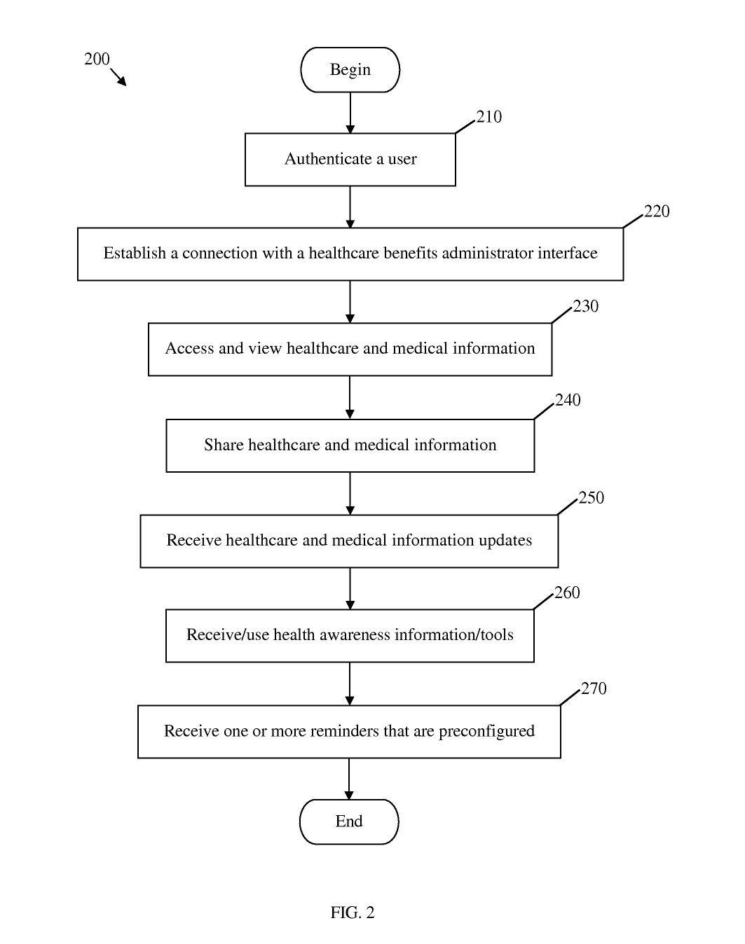

FIG. 2 illustrates an embodiment of a healthcare and medical information management method 200, which may be implemented on a personal device that hosts a healthcare and medical information application, as described above. The method 200 may be implemented to access healthcare and medical information on the personal device (e.g., the mobile device 110) and share at least some of the information with another device (e.g., the second personal device 160). The information may be accessed on a healthcare benefits administrator system (e.g., using the healthcare benefits administrator interface 120) and/or healthcare and medical information databases (e.g., the healthcare benefits database 140).

The method 200 may begin at block 210, where a user may be authenticated. The user of the personal device may be authenticated to identify the user as having a registered healthcare benefits account and hence allow the user to access and use the healthcare and medical information application on the personal device. The user may enter authentication information such as user name and password or may be authenticated using any of the schemes described above. At block 220, a connection may be established with a healthcare benefits administrator interface. The personal device may use any of the wireless technologies described above to establish a wireless link with the healthcare benefits administrator interface. Alternatively, the personal device may establish a fixed communication link with the healthcare benefits administrator interface. The link may be established automatically by the healthcare and medical information application after user authentication. Alternatively, the user may be prompted to allow the personal device to connect to the healthcare benefits administrator interface. In an embodiment, the healthcare and medical information application may communicate with a corresponding application (agent application) at the healthcare benefits administrator interface to establish the link.

At block 230, healthcare and medical information may be accessed and viewed. The user may use a function or option of the application to select, access, and display healthcare and medical information, e.g., about medical records and/or healthcare benefits, on the personal device. The information may be accessed remotely using provided links to the information, such as from the healthcare benefits administrator interface or other source (e.g., the healthcare benefits database 140). The information may not be cached or stored on the personal device while being accessed and viewed. At block 240, healthcare and medical information may be shared. For instance, the information may be accessed via the links and then selected for sharing using an option or function of the application. The information may be shared by sending the links from the personal device to a similar or related application on another device (e.g., the second personal device 160) or via other means (e.g., email), as described above. The information may also be shared by the other device by obtaining the links directly from the healthcare benefits administrator interface or other source without downloading the links to the personal device.

At block 250, healthcare and medical information updates may be received. The updates may be received on the personal device from the healthcare benefits administrator interface or other source, which may belong to an employer for the user of the personal device. The user of the personal device may use or activate an option or function to receive the updates, e.g., when the updates are available or on a regular basis. At block 260, health awareness information/tools may be accessed/used. The information may be requested by the user of the personal device via an option or function or may be pushed by a third party that is authorized to do so by the user. At block 270, one or more reminders that are preconfigured may be received. The reminders may comprise predetermined reminders selected by the user or other reminders that are set by the user. The reminders may be related to the healthcare and medical information or may concern the user of the personal device. The method 200 may then end. In other embodiments, one or more of the blocks 230 to 270 may be optional. Further, at least some of the steps may be combined and implemented as a single or collective step, e.g., at about the same time or time period, or separately, e.g., at different times or time periods, such as when needed or requested.

The healthcare and medical information management system 100 and the healthcare and medical information management method 200 may provide healthcare and medical information to an individual when needed, such as when visiting a doctor or a pharmacist. For example, the application may allow the individual to keep track of his/her personal health records, including health screenings and immunizations, and to share such information (e.g., with a doctor) when needed. The healthcare and medical information application may provide such information and a level of networking in terms of sharing the information. Using the application on a personal device, the individual may network or send the information to a second individual, e.g., another user of a second device in communications with the personal device of the individual. This may be valuable in various situations, such as when the individual leaves his/her child with a caretaker and may want the caretaker to have vital information about the child's medical conditions, medications, doctor information, insurance plan coverage, and/or other relevant information.

The application may allow an individual to access and make use of the healthcare and medical information to make decisions about the individual's health and healthcare benefits at a reasonable or lower cost, e.g., in comparison to using other schemes that require collecting and carrying the information manually and/or accessing the information at a plurality of sources (e.g., healthcare benefits administrators and providers). The application may also be used on a personal device to allow a user to share electronically his/her insurance card or insurance card information with healthcare providers, e.g., via email or facsimile, which may eliminate the need to carry physical insurance cards. The application may comprise portions that work with native functions of a personal device's operating system (such as touch screen phone dialing, the ability to upload photos from the device's camera, etc.) and other portions that integrate and use machine or program code, such as HyperText Markup Language (HTML) content. This may provide the flexibility for a user of the device to experience improved performance of the application and may provide a healthcare and medical information administrator (e.g., an employer) flexibility in pushing content to the device, e.g., via a custom-built content management system.

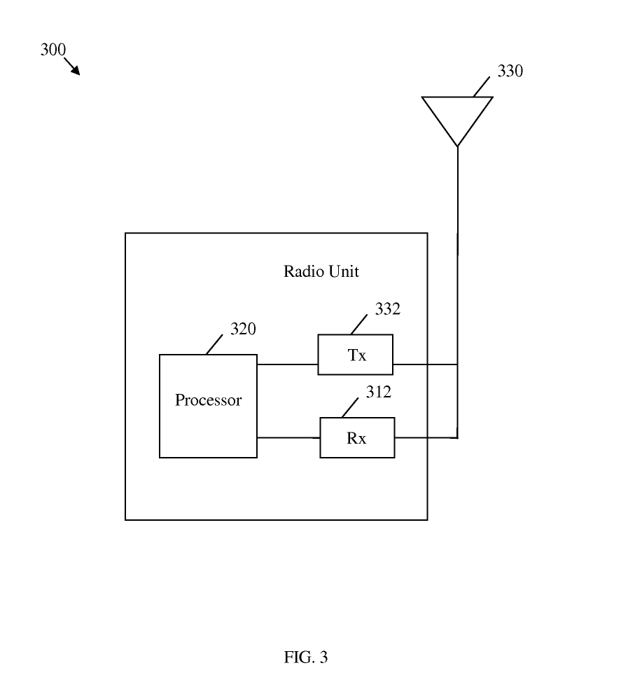

FIG. 3 illustrates an embodiment of a radio unit 300, which may be any device that communicates data (e.g., packets) wirelessly with a network. For instance, the radio unit 300 may be located in a mobile or personal device (e.g., mobile device 110) that exchanges or communicates data with networks or other mobile or personal devices. The radio unit 300 may comprise a receiver (Rx) 312, which may be configured for receiving data, packets, or frames from other components. The radio unit 300 may comprise a logic unit or processor 320 coupled to the receiver 312, which is configured to process the data and determine to which components the data is to be sent. The logic unit or processor 320 may also be configured to support or implement the healthcare and medical information method 200 and at least some of the functions of the healthcare and medical information application. The logic unit or processor 320 may be implemented using hardware, software, or both. The radio unit 300 may also comprise a transmitter (Tx) 332 coupled to the logic unit or processor 320 and configured for transmitting data, packets, or frames to other components. The radio unit 300 may also comprise an antenna 330 that may be coupled to the Rx 312 and/or the TX 332 and configured to enable receiving/sending wireless (e.g., radio) signals.

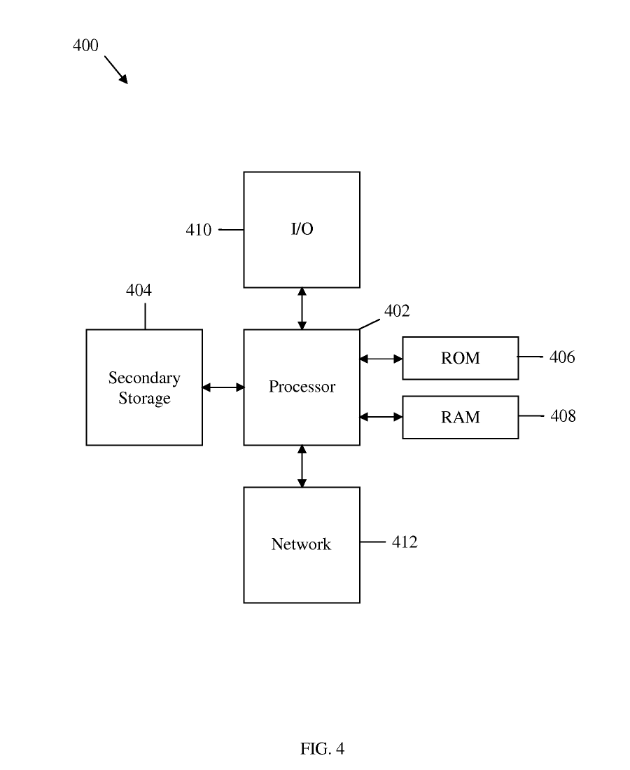

The components described above may be implemented on any general-purpose network component, such as a computer or mobile device with sufficient processing power, memory resources, and network throughput capability to handle the necessary workload placed upon it. FIG. 4 illustrates a typical, general-purpose network component 400 suitable for implementing one or more embodiments of the components disclosed herein. The network component 400 includes a processor 402, e.g., a central processing unit (CPU), which is in communication with memory devices including secondary storage 404, read only memory (ROM) 406, random access memory (RAM) 408, input/output (I/O) devices 410, and network connectivity devices 412. The processor 402 may be implemented as one or more central processing unit (CPU) chips, or may be part of one or more application specific integrated circuits (ASICs) and/or digital signal processors (DSPs).

The secondary storage 404 is typically comprised of one or more disk drives or tape drives and is used for non-volatile storage of data and as an over-flow data storage device if RAM 408 is not large enough to hold all working data. Secondary storage 404 may be used to store programs that are loaded into RAM 408 when such programs are selected for execution. The ROM 406 is used to store instructions and perhaps data that are read during program execution. ROM 406 is a non-volatile memory device that typically has a small memory capacity relative to the larger memory capacity of secondary storage 404. The RAM 408 is used to store volatile data and perhaps to store instructions. Access to both ROM 406 and RAM 408 is typically faster than to second storage 404.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 7 percent, . . . , 70 percent, 71 percent, 72 percent, . . . , 97 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A healthcare and medical information management system comprising:
an administrator interface configured to communicate with a device, to integrate healthcare and medical information for a plurality of individuals including a user of the device, and to provide the device access to and sharing of the healthcare and medical information associated with the user of the device.

2. The healthcare and medical information management system of claim 1, wherein the administrator interface is further configured to communicate with one or more healthcare benefits provider interfaces that are configured to provide the administrator interface healthcare benefits information for integration.

3. The healthcare and medical information management system of claim 1, wherein the administrator interface is further configured to couple to a healthcare and medical information database that is configured to store healthcare and medical information for the individuals.

4. The healthcare and medical information management system of claim 1, wherein the administrator interface is further configured to couple to a network that is configured to allow communications between the administrator interface and the device and to enable the device to access the healthcare and medical information for the user of the device remotely on the administrator interface.

5. The healthcare and medical information management system of claim 1, wherein the administrator interface, the device, or both are configured to communicate with a second device that shares healthcare and medical information with the device that is authorized by the user of the device.

6. The healthcare and medical information management system of claim 1, wherein the healthcare and medical information of the user of the device is accessed remotely without storing and caching the healthcare and medical information on the device.

7. The healthcare and medical information management system of claim 1, wherein the administrator interface is further configured to provide one or more additional devices associated with one or more additional users access to healthcare and medical information associated with the additional users, and wherein the administrator interface is operated by an employer, a healthcare payer or provider organization, a health insurance plan, or other organizations, and wherein the user and the additional users are employees of the employer, health insurance plan members, consumers not associated with any employer, health insurance, or health plan, or combinations thereof.

8. The healthcare and medical information management system of claim 1, wherein the healthcare and medical information associated with the user of the device comprise healthcare benefits information of the user comprising at least one of integrated health, dental, pharmacy and vision insurance coverage information from one or more healthcare insurance providers, one or more medical records of the user, information related to one or more healthcare benefits providers for the user of the device, personal profile information about the user of the device, healthcare and medical information associated with one or more dependents of the user of the device, or combinations thereof.

9. An apparatus comprising a processor configured to:
remotely access personal healthcare and medical information of a user registered with a device on a database of integrated healthcare and medical information for a group of individuals; and
enable a second device to remotely access at least some of the personal healthcare and medical information of the user at the database.

10. The apparatus of claim 9, wherein the processor is configured to implement an application hosted on the device and configured to remotely access and share with the second device the personal healthcare and medical information of the user.

11. The apparatus of claim 10, wherein the application is configured to communicate with a second application hosted on the second device to enable the second application to remotely access at least some of the personal healthcare and medical information of the user that is selected by the user.

12. The apparatus of claim 10, wherein the application comprises a plurality of options including a function for accessing healthcare records and benefits information, a function for sharing information, a function for providing updates and receiving messages, a function for promoting good health, a function for managing content and data used in the application, and a function for providing reminders.

13. The apparatus of claim 12, wherein the function for accessing healthcare records and benefits information enables the user to view on a screen of the device at least one of a summary of at least some of the user's healthcare benefits information and the user's insurance card information in Portable Document Format (PDF) or other format, enables the user to view healthcare spending account information including at least one of a deductible amount remaining for an insurance coverage plan and flexible medical account information, or combinations thereof.

14. The apparatus of claim 12, wherein the function for sharing information enables the user to establish a network of other users that are authorized by the user for sharing personal healthcare and medical information of the user, enables the user to send via email at least one summary of at least some of the user's healthcare benefits information and the user's insurance card information in Portable Document Format (PDF), or combinations thereof.

15. The apparatus of claim 12, wherein the function for receiving updates enables a healthcare benefits administrator to push information updates that are relevant to the user onto the application on the device.

16. The apparatus of claim 12, wherein the function for promoting good health enables the user to obtain information relevant to the user's well-being, use a tool that promotes health of the user, or both, enables a third party to push onto the device information relevant to the user's well-being, or combinations thereof.

17. A healthcare and medical information access and sharing application comprising instructions that cause a mobile device to:
authenticate a user;
establish a connection with a medical benefits administrator interface that manages healthcare and medical information for a plurality of individuals including the authenticated user;
access remotely healthcare and medical information associated with the authenticated user;
display the healthcare and medical information on the mobile device; and
share selected healthcare and medical information of the authenticated user with one or more personal devices.

18. The application of claim 17, wherein the instructions further cause the mobile device to:
receive medical information about the authenticated user, one or more dependents of the authenticated user, or both; and
send the medical information to the medical benefits administrator interface to add the medical information to the managed healthcare and medical information.

19. The application of claim 18, wherein the medical information is entered on the mobile device using one or more input systems of the mobile device, is received electronically on the mobile device using one or more communications technologies, or combinations thereof.

20. The application of claim 17, wherein the instructions further cause the mobile device to receive one or more reminders based on preconfigured criteria in the application, by the authenticated user, or both.
